(19) United States
(12) Patent Application Publication
(10) Pub. No.: US 2011/0073739 A1
(43) Pub. Date: Mar. 31, 2011

(54) Detachable stand

(75) Inventor: Cheng-Hung Chiu, Taichung (TW)

(73) Assignee: REXON INDUSTRIAL CORP., LTD., Taichung (TW)

(21) Appl. No.: 12/882,646

(22) Filed: Sep. 15, 2010

(30) Foreign Application Priority Data
Sep. 29, 2009 (TW) 098133050

(51) Int. Cl. F16M 11/38

(52) U.S. Cl. 248/432

(57) ABSTRACT

A detachable stand includes a transverse bar having a first coupling hole and a second coupling hole at each of two distal ends thereof, a pair of upper support rods coupled to the first coupling holes of the transverse bar, a pair of lower support rods coupled to the second coupling holes of the transverse bar, and quick-release mechanism provided at the transverse bar and operable to lock the pair of upper support rods and the pair of lower support rods to the transverse bar. When the quick-release mechanism is released, the pair of upper support rods and the pair of lower support rod are unlocked and able to be removed from the transverse bar, reducing space requirement for storage of the detachable stand.

This application claims, under 35 U.S.C. §119, priority to Taiwanese Application No. 098133050, filed Sep. 29, 2009, which application is hereby incorporated by reference in its entirety, inclusive of the specification, claims, and drawings.

### FIELD OF THE INVENTION

The present disclosure relates to support means for supporting a power tool, and more particularly, to a detachable stand, which can be detached from the power tool when not in use.

### BACKGROUND

Taiwan Patent Number M283108 discloses a stand entitled “Stand for machine.” According to this design, the stand includes a plurality of support legs and a plurality of bearing members. Coupling grooves and coupling flanges are provided between the support legs and the bearing members so that the support legs and the bearing members can be fastened together. To enhance connection stability between the support legs and the bearing members, locking members are provided to lock the support legs and the bearing members in position.

The aforesaid stand has a big size that requires a large amount of storage space when it is not used. In order to save storage space, the support legs and the bearing members can be detached from one another. However, it requires a significant amount of time and labor to detach the support legs and the bearing members.

U.S. Pat. No. 7,441,760 discloses a stand entitled “Work table,” which includes a support leg arrangement formed from a plurality of telescoping legs and a tool or workpiece bearing portion mounted on the support leg arrangement. The bearing portion includes a first bearing member and a second bearing member. At least one guide bar extends between the first and second bearing members. To permit movement, the first bearing member is movably arranged on the guide bar. The second bearing member is fixed relative to first bearing member by the support leg arrangement. This structure of the work table is collapsible, however the table still occupies a large amount of storage space when collapsed.

### SUMMARY

The present disclosure of a detachable stand provides advantageous solutions to the above discussed drawbacks. In particular, a detachable stand is provided, which is easy to assemble and disassemble, and which effectively reduces the space occupied when the stand is collapsed.

An exemplary embodiment of a detachable stand according to the present disclosure includes a transverse rod, a pair of upper support rods, a pair of lower support rods, and a quick-release mechanism. The transverse rod has at least one first coupling hole and at least one second coupling hole at each of two opposed first and second ends thereof. The upper support rods are respectively inserted with the bottom ends thereof into the first coupling holes of the transverse rod. The lower support rods are respectively inserted with the top ends thereof into the second coupling holes of the transverse rod. The quick-release mechanism is mounted in the transverse bar and is adapted for locking the upper support rods and the lower support rods to the transverse bar.

When the quick-release mechanism is tightened, the upper support rods and the lower support rods are locked to the transverse bar. Thus, the detachable stand can be used to support a machine tool above the ground. When the quick-release mechanism is loosened, the upper support rods and the lower support rods are unlocked from the transverse bar and can be removed from the transverse bar. Thus, the detachable stand can be detached rapidly to reduce the space occupied when the stand is not in use.

### BRIEF DESCRIPTION OF THE DRAWINGS

FIG. 1 is an elevational view of a detachable stand in an extended configuration in accordance with a first embodiment of the present disclosure.

FIG. 2 is a schematic side view of the detachable stand shown in FIG. 1.

FIG. 3 is an enlarged view of a part of the detachable stand shown in FIG. 2, showing the handle of the quick-release mechanism in the locking position.

FIG. 4 is an exploded view of the detachable stand shown in FIG. 3 showing the detailed structure of the detachable stand.

FIG. 5 is a view similar to FIG. 3, showing the handle of the quick-release mechanism in the unlocking position.

FIG. 6 is an end view of a detachable stand in accordance with a second embodiment of the present disclosure.

FIG. 7 corresponds to FIG. 6, showing the pair of upper support rods and the pair of lower support rods detached from the transverse bar.

### DETAILED DESCRIPTION

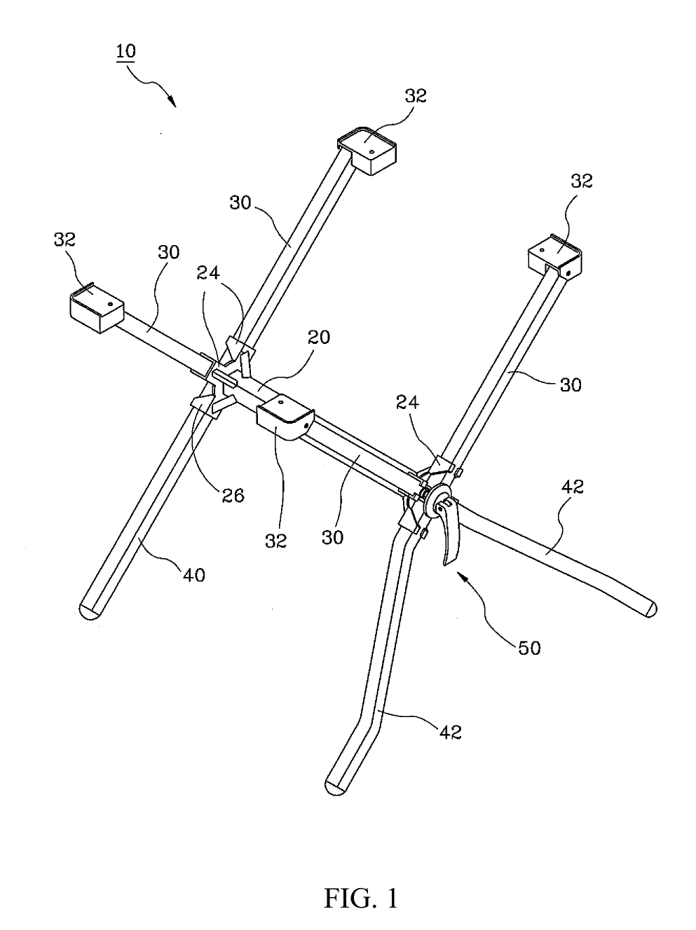

A first embodiment of a detachable stand 10 according to the present disclosure is shown in FIGS. 1 through 5. The detachable stand 10 includes a transverse bar 20, pairs of upper support rods 30, pairs of lower support rods 40; 42 and a quick-release mechanism 50.

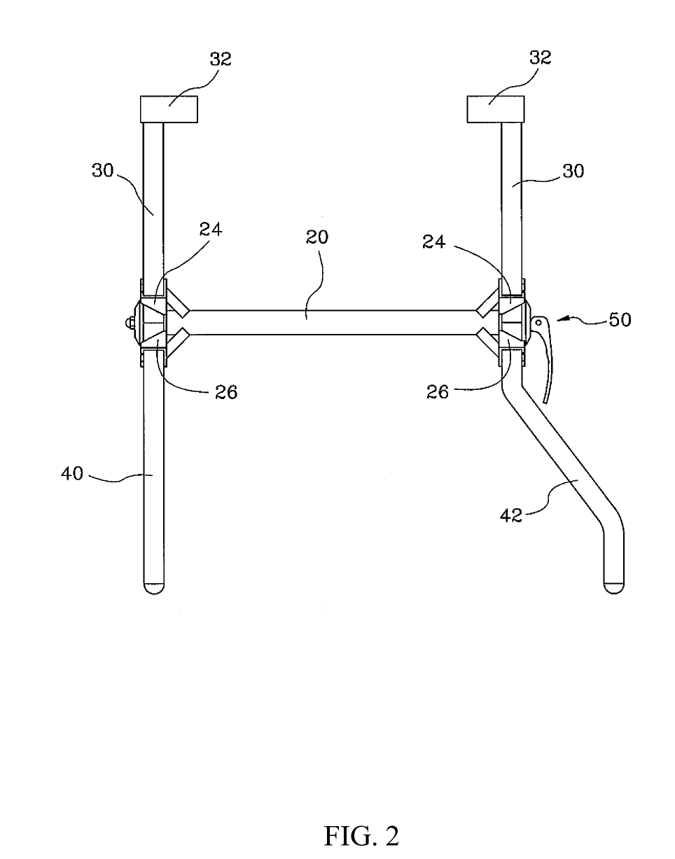

Referring to FIGS. 2, 4 and 5, the transverse bar 20 has an axial hole 22 extending through the opposed first and second ends thereof, a pair of first coupling lugs 24 and a pair of second coupling lugs 26 bilaterally arranged at each of the two opposed first and second ends.

Each first coupling lug 24 extends obliquely upwardly from one end of the transverse bar 20 in the radial direction, defining therein a first coupling hole 242. Each second coupling lug 26 extends obliquely downwardly from one end of the transverse bar 20 in the radial direction, defining therein a second coupling hole 262. Additionally, the two pairs of first coupling lugs 24 and the two pairs of second coupling lugs 26 are equiangularly spaced around the axis of the transverse bar 20. Further, the first coupling lugs 24 and second coupling lugs 26 of the transverse bar 20 each have side opening 28.

According to this embodiment, the upper support rods 30 are straight rod members, each having the bottom end thereof inserted into one coupling hole 242 of the transverse bar 20 and the top end thereof provided with a bearing block 32 for supporting a machine tool thereon.

According to this embodiment, the two lower support rods 40 are straight rod members, and the other two lower support rods 42 are slightly curved. Each lower support rod 40 or 42 has the top end thereof inserted into one coupling hole 262 of the transverse bar 20 and the bottom end thereof arranged for contacting the ground.

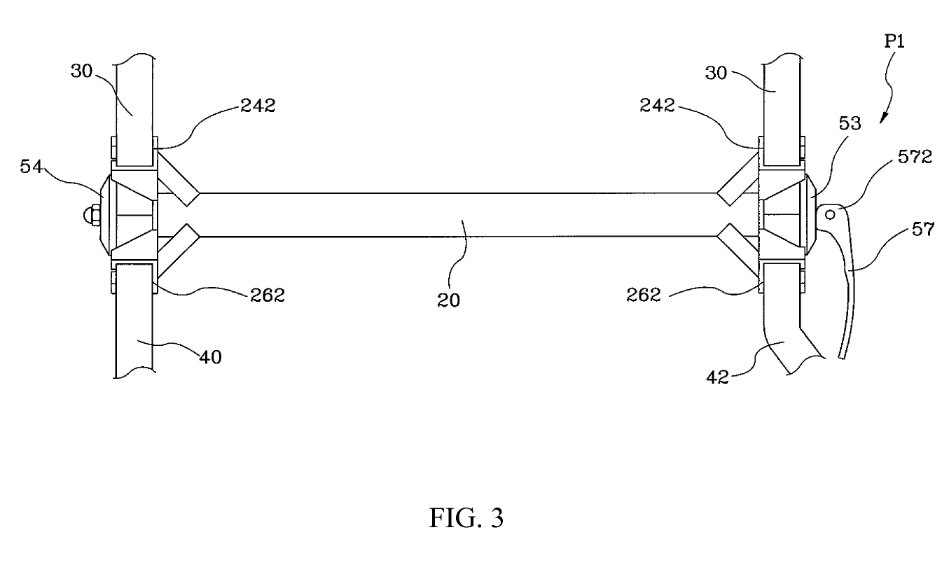

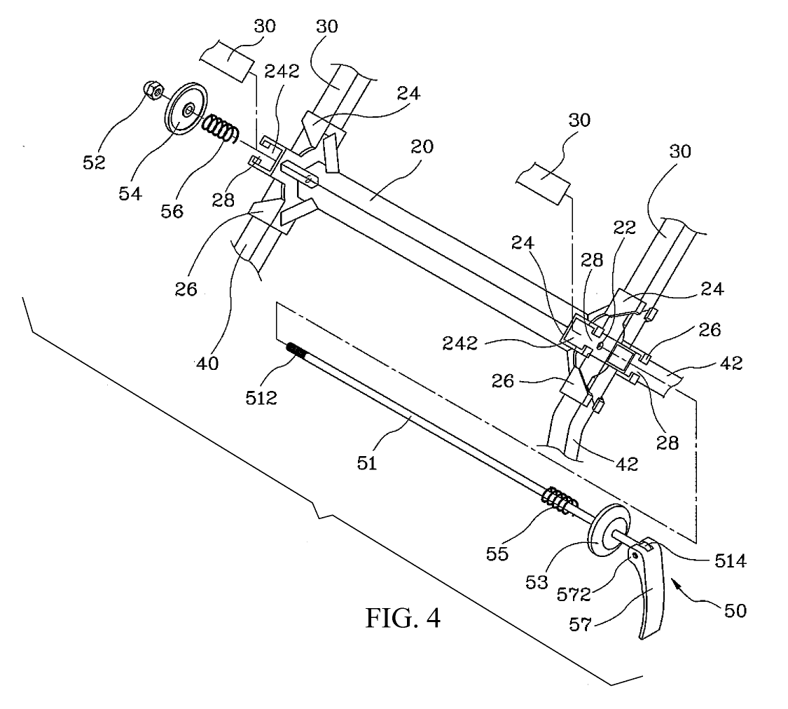

Referring to FIGS. 3 and 4, the quick-release mechanism 50 has a pull rod 51, an adjustment nut 52, two clamping plates 53; 54, two spring members 55; 56, and a handle 57.

The pull rod 51 is inserted through the axial hole 22 of the transverse bar 20, and includes an opposed screw end 512 and a coupling end 514. The adjustment nut 52 is threaded onto the screw end 512 of the pull rod 51.

The two clamping plates 53; 54 are respectively arranged on the coupling end 514 and screw end 512 of the pull rod 51. The two spring members 55; 56 are concentrically arranged on the pull rod 51, and respectively abutting between one of the first and second ends of the transverse bar 20 and one of the two clamping plates 53; 54.

The handle 57 has a cam portion 572 located on one end thereof and is pivotally coupled to the coupling end 514 of the pull rod 51 in such a manner that the handle 57 can be moved relative to the pull rod 51 between a locking position P1 and an unlocking position P2.

When the handle 57 is in the locking position P1 as shown in FIG. 3, one clamping plate 53 is forced by the cam portion 572 to hold down one pair of upper support rods 30 and one pair of lower support rods 42, and the other clamping plate 54 is forced by the nut 52, which is pulled by the cam portion 572 via the pull rod 51, to hold down the other pair of upper support rods 30 and the other pair of lower support rods 40.

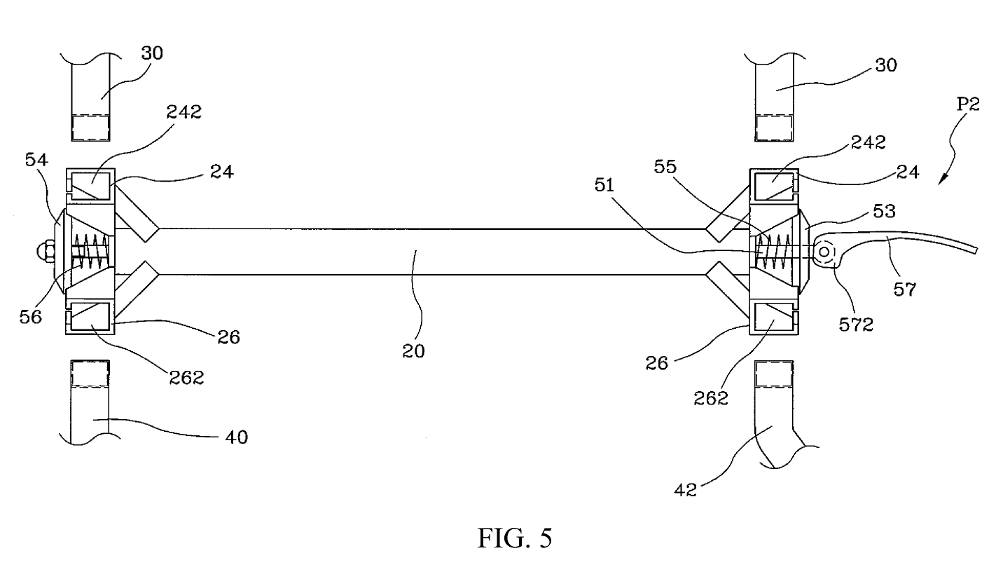

When the handle 57 is in the unlocking position P2 as shown in FIG. 5, the cam portion 572 is released from the associated clamping plate 53 for enabling the associated clamping plate 53 to be pushed outwards by a biasing force applied by one spring member 55. Meanwhile, the pull rod 51 is not pulled by the cam portion 572 and thus enables the associated clamping plate 54 to also to be pushed outwards by a biasing force applied by one spring member 56. Therefore the upper support rods 30 and the lower support rods 40, 42 are released from the constraint of the two clamping plates 53; 54 and are movable away from the coupling holes 242; 262 of the transverse bar 20 respectively.

In use of the detachable stand 10, the lower support rods 40; 42 are inserted into the coupling holes 262 of the second coupling lugs 26 of the transverse bar 20 respectively to allow the bottom ends of the lower support rods 40; 42 to be supported at the ground. Next the upper support rods 30 are inserted into the coupling holes 242 of the first coupling lugs 24 of the transverse bar 20, and then the handle 57 is moved to the locking position P1 as shown in FIG. 3 to allow the upper support rods 30 and the lower support rods 40; 42 be clamped in between the first and second ends of the transverse bar 20 and the clamping plates 53; 54 respectively. Therefore, the upper support rods 30 and the lower support rods 40; 42 are locked to the transverse bar 20 in the respective coupling holes 242; 262.

Thus, the user can mount a machine tool, for example, a saw machine (not shown) on the bearing blocks 32 of the upper support rods 30 to facilitate operation. Further, the user can rotate the nut 52 to adjust the distance between the two clamping plates 53; 54 so that the handle 57 can be adjusted to the appropriate tightness subject to the user's preference.

After each use of the detachable stand 10, the handle 57 is moved upwards from the locking position P1 shown in FIG. 3 to the unlocking position P2 shown in FIG. 5 to release the force applied by clamping plates 53; 54 to the upper support rods 30 and the lower support rods 40; 42. At this time, the user can remove the upper support rods 30 and the lower support rods 40; 42 from the coupling holes 242; 262 of the transverse bar 20 respectively.

As stated above, by means of operating the quick-release mechanism, the user can detach the detachable stand conveniently and rapidly to reduce the space occupied when the stand is not in use. Further, when the detachable stand is set up, it provides an excellent supporting effect.

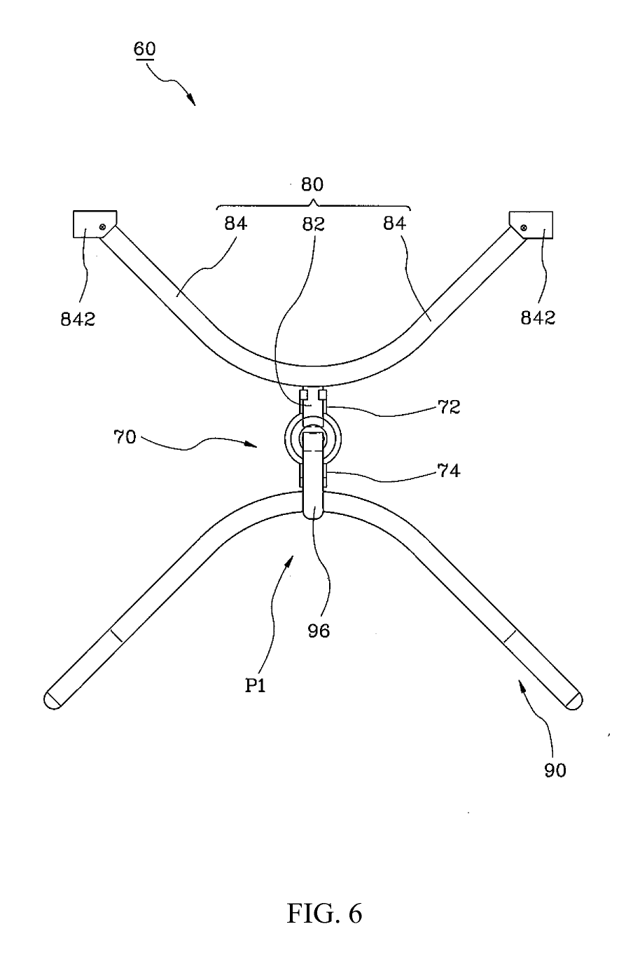

It is to be understood that the detachable stand can be variously embodied. FIG. 6 illustrates a second embodiment of the present disclosure. The detachable stand 60 according to this second embodiment is substantially similar to the aforesaid first embodiment with the exception of the below noted differences.

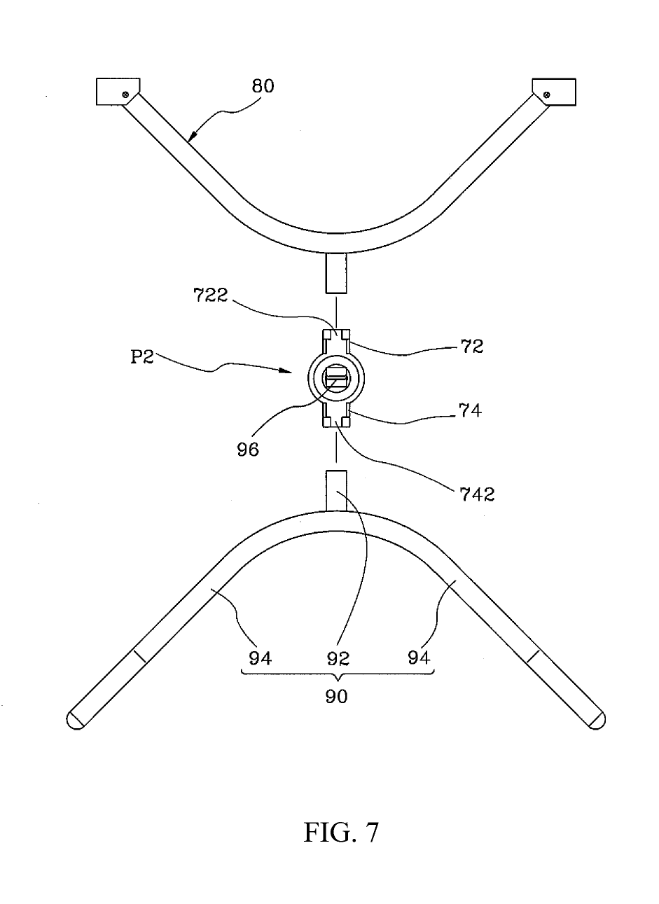

Referring to FIG. 7, the transverse bar 70 has a first coupling lug 72 and a second coupling lug 74 respectively located on each of opposed first and second ends thereof. Each first coupling lug 72 extends vertically upwardly from one end of the transverse bar 70 in the radial direction, defining therein a first coupling hole 722. Each second coupling lug 74 extends vertically downwardly from one end of the transverse bar 70 in the radial direction, defining therein a second coupling hole 742.

The upper support rods 80 are Y-shaped bars, each having a main leg portion 82 and two supporting leg portions 84. The main leg portions 82 of the upper support rods 80 are respectively inserted into the first coupling holes 722 of the transverse bar 70. The supporting leg portions 84 each have a bearing block 842 at the top end.

The lower support rods 90 are also Y-shaped bars, each having a main leg portion 92 and two sub-leg portions 94. The main leg portions 92 of the lower support rods 90 are respectively inserted into the second coupling holes 742 of the transverse bar 70. The sub-leg portions 94 of the lower support rods 90 are arranged to contact the ground.

The mounting and dismounting operations of this second embodiment are generally the same as the aforesaid first embodiment. When the handle 96 is in the locking position P1 shown in FIG. 6, the upper support rods 80 and the lower support rods 90 are locked to the transverse bar 70 in the respective first coupling holes 722 and second coupling holes 742 to provide an excellent supporting effect.

When the handle 96 is moved to the unlocking position P2 shown in FIG. 7, the upper support rods 80 and the lower support rods 90 can be removed from the first coupling holes 722 and second coupling holes 742 of the transverse bar 70 respectively to detach the detachable stand.

A prototype of detachable stand has been constructed with the features of FIGS. 1˜7. The detachable stand functions smoothly to provide all of the features discussed above.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A detachable stand, comprising:
a transverse rod having at least one first coupling hole and at least one second coupling hole at each of two opposed first and second ends thereof;
at least one pair of upper support rods respectively detachably inserted with a bottom end thereof into the at least one first coupling hole of said transverse rod;
at least one pair of lower support rods respectively detachably inserted with a top end thereof into the at least one second coupling holes of said transverse rod; and
a quick-release mechanism mounted in said transverse bar and adapted for locking said at least one pair of upper support rods and said at least one pair of said lower support rods to the first and second ends of said transverse bar.

2. The detachable stand according to claim 1, wherein said transverse bar has at least one first coupling lug and at least one second coupling lug located on each of the opposed first and second ends thereof, each said first coupling lug extending from one of the opposed first and second ends of said transverse bar radially upwards and defining therein one said first coupling hole, each said second coupling lug extending radially downwards from one of the opposing first and second ends of said transverse bar and defining therein one said second coupling hole.

3. The detachable stand according to claim 2, wherein the first coupling lugs and second coupling lugs of said transverse bar each have an opening.

4. The detachable stand according to claim 2, further comprising two pairs of upper support rods and two pairs of lower support rods, wherein said transverse bar has two said first coupling lugs and two said second coupling lugs located on each of the two opposed first and second ends thereof and equiangularly spaced around the longitudinal direction of said transverse bar.

5. The detachable stand according to claim 4, wherein at least two said upper support rods are straight legs.

6. The detachable stand according to claim 4, wherein at least two said lower support rods are straight legs.

7. The detachable stand according to claim 1, wherein said upper support rods are Y-shaped legs each having a main leg portion and two supporting leg portions, the main leg portions of said upper support rods being respectively inserted into said first coupling holes of said transverse bar; said lower support rods are Y-shaped legs each having a main leg portion and two sub-leg portions, the main leg portions of said lower support rods being respectively inserted into said second coupling holes of said transverse bar.

8. The detachable stand according to claim 1, wherein each said upper support rod has a bearing block located on a top end thereof.

9. The detachable stand according to claim 1, wherein said quick-release mechanism comprises:
a pull rod inserted through an axial hole of said transverse bar;
two clamping plates respectively arranged on two distal ends of said pull rod outside the opposed first and second ends of said transverse bar; and
a handle having a cam portion located on one end thereof and pivotally coupled to one end of said pull rod and movable relative to said pull rod between a locking position, where said two clamping plates hold down said upper support rods and said lower support rods in the respective first coupling holes and second coupling holes of said transverse bar, and an unlocking position where said two clamping plates are released from said upper support rods and said lower support rods for allowing removal of said upper support rods and said lower support rods from the first coupling holes and second coupling holes of said transverse bar respectively.

10. The detachable stand according to claim 9, wherein said quick-release mechanism further comprises an adjustment nut threaded onto one end of said pull rod remote from said handle, and two spring members concentrically arranged on said pull rod and respectively abutting between the opposing first and second ends of said transverse bar and said clamping plates.
